(19) United States
(12) Patent Application Publication
(10) Pub. No.: US 2017/0284621 A1
(43) Pub. Date: Oct. 5, 2017

(54) LAMP APPARATUS FOR VEHICLE

(71) Applicant: Hyundai Motor Company, Seoul (KR)

(72) Inventors: Jin Ho Na, Yongin (KR); Jik Soo Shin, Incheon (KR); Byoung Suk Ahn, Suwon (KR)

(21) Appl. No.: 15/264,129

(22) Filed: Sep. 13, 2016

(30) Foreign Application Priority Data
Mar. 31, 2016 (KR) 10-2016-0039072

(51) Int. Cl. F21S 8/10

(52) U.S. Cl. CPC F21S 48/1225; F21S 48/1305; F21S 48/14; F21S 48/1757

(57) ABSTRACT

A lamp apparatus for a vehicle is provided. The lamp apparatus creates a specific image of a beam pattern from a low beam or a high beam, increases the visibility of an image and improves light distribution efficiency. A lamp apparatus includes an optical unit having a plurality of light sources disposed at different positions and concentrates light from the light sources to a single point. A reflecting unit disposed on a path of light from the optical unit reflects the light radiated from the optical unit to different paths. A shield unit is disposed between the optical unit and the reflecting unit on the path of radiated light from the light sources and obstructs a portion of the light to separate the light traveling to the reflecting unit. A lens unit receives the light separated by the shield unit and reflects and transmits the light to the exterior.

### CROSS REFERENCE TO RELATED APPLICATION

The present application claims priority to Korean Patent Application No. 10-2016-0039072, filed Mar. 31, 2016, the entire contents of which are incorporated herein for all purposes by this reference.

### BACKGROUND

### Field of the Invention

The present invention relates to a lamp apparatus for a vehicle and more particularly to a lamp apparatus that forms a clear light image by ensuring the quantity of light when a headlamp radiates a low beam or a high beam.

### Description of the Related Art

Generally, a headlamp that is designed to illuminate the front area of a vehicle by radiating light forward from the vehicle provides a driver with visual information by radiating light in the forward direction while the vehicle is driven during low light conditions. Accordingly, the forward view of a driver is ensured during low light conditions and the driver is able to see other vehicles and obstacles on a roadway, thereby improving driving safety. Recently, a technology that provides specific information to a driver using a structure that controls dark sections and bright sections of radiated light has been applied to low light driving situations. To utilize this technology, a Digital Micro-mirror Device (DMD) is used to create specific images. However, when an image is created from light radiated from one light source and transmitted through a DMD the entire surface of the DMD is not utilized and a substantial portion of unused area remains in the DMD. Light traveling through the unused area does not accurately reach to the roadway. Therefore, a technology is needed that increases the visibility of patterns on a roadway and improves the efficiency of the light distribution.

The above information disclosed in this section is merely for enhancement of understanding of the background of the invention and therefore it may contain information that does not form the prior art that is already known in this country to a person of ordinary skill in the art.

### SUMMARY

The present invention provides a lamp apparatus for a vehicle that creates a specific image in a beam pattern, increases the visibility of an image, and improves light distribution efficiency.

In one aspect of the present invention, a lamp apparatus for a vehicle may include an optical unit having a plurality of light sources disposed at different positions and may be configured to concentrate light radiated from the light sources to a single point, a reflecting unit disposed on a path of light from the optical unit and configured to reflect the light radiated from the light sources of the optical unit to different paths, a shield unit disposed between the optical unit and the reflecting unit on the path of the light radiated from the light sources and configured to separate the light traveling to the reflecting unit by obstructing a portion of the light and a lens unit configured to receive the light separated by the shield unit and then reflected, and configured to transmit the light to the exterior.

The optical unit may include a first optical unit and a second optical unit disposed at different positions to radiate light to the reflecting unit. The first optical unit may include a first light source configured to radiate light and a first condenser configured to condense the light radiated from the first light source. The second optical unit may include a second light source configured to radiate light and a second condenser configured to condense the light radiated from the second light source.

The reflecting unit may be switched and may be configured to reflect the light radiated from the light sources of the optical unit to form an image. The reflecting unit may be a Digital Micro-mirror Device (DMD) that may include a plurality of micro reflective mirrors configured to be individually switched, and may be configured to reflect incident light to form a predetermined image. The reflecting unit may be divided into a first section that receives the light from the first optical unit and a second section that receives the light from the second optical unit, and the light reflected from the first section and the second section may be transmitted to the lens unit along different paths.

The lens unit may include a first transmissive lens configured to receive the light reflected from the first section of the reflecting unit and a second transmissive lens configured to receive the light reflected from the second section. The shield unit may include a first shield that obstructs a portion of the light from the first optical unit to prevent the light from the first optical unit from being transmitted to the second section of the reflecting unit and a second shield that obstructs a portion of the light from the second optical unit to prevent the light from the second optical unit from being transmitted to the fiat section of the reflecting unit.

The first shield of the shield unit may be disposed in front of the first condenser on the path of the light radiated from the first light source and the second shield may be disposed in front of the second condenser on the path of the light radiated from the second light source. The first shield of the shield unit may be disposed in front of the first light source on the path of the light radiated from the fiat light source and the second shield may be disposed in front of the second light source on the path of the light radiated from the second light source. The first shield of the shield unit may be disposed among a plurality of lenses of the first condenser on the path of the light radiated from the first light source and the second shield may be disposed among a plurality of lenses of the second condenser on the path of the light radiated from the second light source.

According to the lamp apparatus for a vehicle having the structure described above, a specific image in a beam pattern may be famed to increase the visibility of the image and improve the efficiency of the light distribution.

### BRIEF DESCRIPTION OF THE DRAWINGS

The above and other objects, features and other advantages of the present invention will be more clearly understood from the following detailed description when taken in conjunction with the accompanying drawings, in which:

FIGS. 1 and 2 are exemplary views showing a lamp apparatus for a vehicle according to an exemplary embodiment of the present invention; and

FIGS. 3 to 5 are exemplary views showing various exemplary embodiments of the present invention of the lamp apparatus for a vehicle shown in FIG. 1.

### DETAILED DESCRIPTION

Lamp apparatuses for a vehicle according to exemplary embodiments of the present invention are described hereafter with reference to the accompanying drawings. The present invention will be described more fully hereinafter with reference to the accompanying drawings, in which exemplary embodiments of the invention are shown. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, in order to make the description of the present invention clear, unrelated parts are not shown and, the thicknesses of layers and regions are exaggerated for clarity. Further, when it is stated that a layer is “on” another layer or substrate, the layer may be directly on another layer or substrate or a third layer may be disposed therebetween.

It is understood that the term “vehicle” or “vehicular” or other similar term as used herein is inclusive of motor vehicle in general such as passenger automobiles including sports utility vehicles (SUV), buses, trucks, various commercial vehicles, watercraft including a variety of boats, ships, aircraft, and the like and includes hybrid vehicles, electric vehicles, combustion, plug-in hybrid electric vehicles, hydrogen-powered vehicles and other alternative fuel vehicles (e.g. fuels derived from resources other than petroleum).

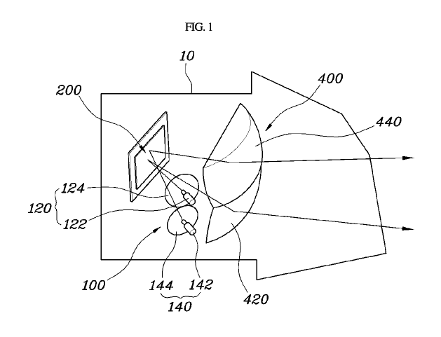

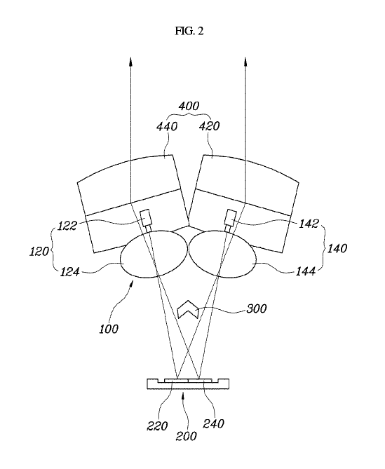

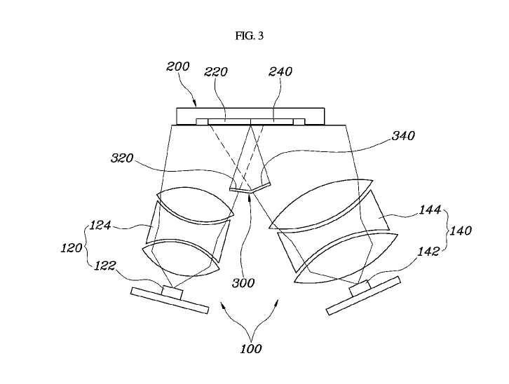

FIGS. 1 and 2 are exemplary views showing a lamp apparatus for a vehicle according to an exemplary embodiment of the present invention. FIGS. 3 to 5 are exemplary views showing various exemplary embodiments of the lamp apparatus for a vehicle shown in FIG. 1.

A lamp apparatus for a vehicle of the present invention, as shown in FIGS. 1 and 2 may include an optical unit 100 that has a plurality of light sources disposed at different positions and configured to concentrate light radiated from the light sources to a single point, a reflecting unit 200 disposed on a path of light from the optical unit 100 and may be configured to reflect the light radiated from the light sources of the optical unit 100 to different paths, a shield unit 300 disposed between the optical unit 100 and the reflecting unit 200 on the path of the light radiated from the light sources and that may be configured to separate the light traveling to the reflecting unit 200 by obstructing a portion of the light and a lens unit 400 that receives the light separated by the shield unit 300 and to reflect and transmit the light to the exterior. In particular, the present invention may include an optical unit 100, a reflecting unit 200, a shield unit 400, and a lens unit 400, which may be housed within a case 10.

The optical unit 100 may have a plurality of light sources configured to radiate light and the light radiated from the light sources may be transmitted to the reflecting unit 200. The reflecting unit 200 may be switched and may be configured to reflect the light radiated from the light sources of the optical unit 100 and from an image. The reflecting unit 200 may reflect the light radiated from the light sources at different positions to a roadway through the lens unit 400. In particular, the shield unit 300 may be disposed between the optical unit 100 and the reflecting unit 200 in the present invention and may obstruct a portion of the light radiated from the light sources of the optical unit 100 to separate light traveling to the reflecting unit 200. Accordingly, when the light is separated and reflected from the reflecting unit 200, the light may be separated into a low beam and a high beam and then may be output through the lens unit 400.

Further, the optical unit 100 of the present invention may include a first optical unit 120 and a second optical unit 140 disposed at different positions and configured to radiate light to the reflecting unit 200. When the optical unit 100 is composed of the first optical unit 120 and the second optical unit 140 and the first and second optical units 120 and 140 are disposed symmetrically with the reflecting unit 200 therebetween, the light beams radiated from the first optical unit 120 and the second optical unit 140 do not interfere with each other. In other words, the first optical unit 120 and the second optical unit 140 both radiate light to the reflecting unit 200. However, when the radiation directions of the first optical unit 120 and the second optical unit 140 overlap each other, the light beams from the first optical unit 120 and the second optical unit 140 may be combined and the specific colors or images are not clearly shown. Accordingly, the first optical unit 120 and the second optical unit 140 may be disposed at different positions with respect to the reflecting unit 200. The light beam from the first optical unit 120 and the light beam from the second optical unit 140 may be separately reflected from the reflecting unit 200.

The first optical unit 120 may include a first light source 122 configured to radiate light and a first condenser 124 configured to condense the light radiated from the first light source 122. The second optical unit 140 may include a second light source 142 configured to radiate light and a second condenser 144 configured to condense the light radiated from the second light source 142. Accordingly, as shown in FIG. 1, the first optical unit 120 may include the first light source 122 configured to radiate light and the first condenser 124 configured to condense the light concentrate radiated from the first light source 122 to the reflecting unit 200. Further, the second optical unit 140 may be disposed at a predetermined distance from the first optical unit 120 and may include the second light source and 142 and the second condenser 144 configured to concentrate light radiated from the second light source 142 on the reflecting unit 200.

The first light source 122 and the second light source 142 may radiate different colors of light, and the ability of the first condenser 124 and the second condenser 144 to condense light may be adjusted based on a low beam characteristic or a high beam characteristic. The reflecting unit 200 may be a DMD that may include a plurality of micro reflective mirrors which are individually switched and may reflect incident light to form a predetermined image. When the reflecting unit 200 is switched, the path of incident light may be adjusted when the angles of the micro reflective mirrors are adjusted. Further, a motor may be configured to adjust the angles of the micro reflective mirrors by adjusting a duty ratio using Pulse Width Modulation (PWM) control.

The reflecting unit 200 may be divided into a first section 220 configured to receive the light from the first optical unit 120 and a second section 240 configured to receive the light from the second optical unit 140. The light reflected from the first section 220 and the light reflected from the second section 240 may travel to the lens unit 400 along different paths. As shown in FIG. 3, the reflecting unit 200 may be divided into a first section 220 and a second section 240. The first section 220 may reflect light as a low beam and the second section 240 may reflect light as a high beam. Further, the first section 220 and the second section 240 may form different images from incident light to separate a low beam image and a high beam image.

The lens unit 400 may include a first transmissive lens 420 configured to receive the light reflected from the first section 220 of the reflecting unit 200 and a second transmissive lens 440 configured to receive the light reflected from the second section 240. The first transmissive lens 420 and the second transmissive lens 440 of the lens unit 400 may be configured to receive the light reflected from the first section 220 and the second section 240, respectively. The light radiated from the first optical unit 120 and reflected from the first section 220 of the reflecting unit 200 may be transmitted to the exterior with a low beam characteristic through the first transmissive lens 420, while the light radiated from the second optical unit 140 and reflected from the second section 240 of the reflecting unit 200 may be transmitted to the exterior with a high beam characteristic through the second transmissive lens 440, whereby a low beam and a high beam may be achieved. Generally, a low beam and a high beam form images at different distances when radiated on a roadway. Accordingly, the focal distance and the degree of condensing of the first transmissive lens 420 and the second transmissive lens 440 may be set differently, based on the characteristics of the low beam and high beam.

The shield unit 300 may include a first shield 320 that obstructs a portion of the light from the first optical unit 120 to prevent the light from the first optical unit 120 from being transmitted to the second section 240 of the reflecting unit 200 and a second shield 340 that obstructs a portion of the light from the second optical unit 140 to prevent the light from the second optical unit 140 from being transmitted to the first section 220 of the reflecting unit 200. In the present invention, the first optical unit 120 and the second optical unit 140 to radiate light to produce a low beam and a high beam, respectively, and the light from the first optical unit 120 and the second optical unit 140 may be transmitted to the reflecting unit 200. The reflecting unit 200 may be divided into the first section 220 configured to receive the light from the first optical unit 120 and the second section 240 configured to receive the light from the second optical unit 140. In particular, the light reflected from the first section 220 may be transmitted to the first transmissive lens 420 and the light reflected from the second section 240 may be transmitted to the second transmissive lens 440, to produce a low beam and a high beam, respectively.

The reflecting unit 200 may produce a high beam and a lower beam using the area including the first section 220 and the second section 240. However, when the light beams from the first optical unit 120 and the second optical unit 140 are mixed regardless of the first section 220 and the second section 240, the images formed from the low beam and the high beam may be unclear and the boundary line between the low beam and the high beam may also be unclear.

Accordingly, the first shield 320 may obstruct the light from the first optical unit 120 from being transmitted to the second section 240. For example, the first section 220 of the reflecting unit 200 and the second shield 340 that allows the light from the second optical unit 140 may obstruct light from being transmitted to the first section 220, and to the second section 240 of the reflecting unit 200. In other words, a portion of the light radiated from the first optical unit 120 may be transmitted toward the second section 240 of the reflecting unit 200 and may be obstructed by the first shield 320. Further, when a portion of the light that is radiated from the second optical unit 140 and transmitted toward the first section 220 of the reflecting unit 200 may be obstructed by the second shield 340 to produce uniformly distributed light throughout the area of the reflecting unit 200. The position of the shield unit 300 is described through various exemplary embodiments. As shown in FIG. 3, the first shield 320 of the shield unit 300 may be disposed in front of the first condenser 124 on the path of the light radiated from the first light source 122. The second shield 340 may be disposed in front of the second condenser 144 on the path of the light radiated from the second light source 142. When the first shield 320 is positioned in front of the first condenser 124 and the second shield 340 is positioned in front of the second condenser 144, the light beam from the first light source 122 and the light beam from the second light source 142 may be separated at the joint of the first section 220 and the second section 240. Accordingly, the light radiated from the first light source 122 may be prevented from entering the second section 240 and the light radiated from the second light source 142 may be prevented from entering the first section 220. Further, the first shield 320 and the second shield 340 may be separated, or may be integrated to simplify the structure.

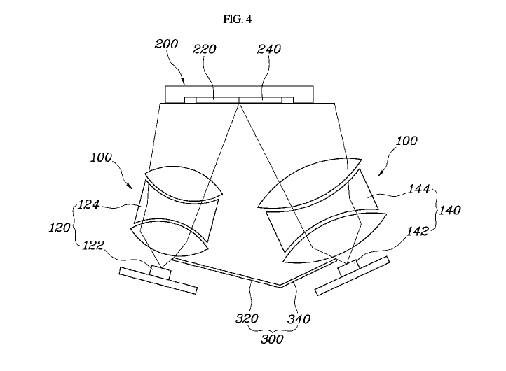

As shown in FIG. 4 in another exemplary embodiment, the first shield 320 of the shield unit 300 may be disposed in front of the first light source 122 on the path of the light radiated from the first light source 122 and the second shield 340 may be disposed in front of the second light source 142 on the path of the light radiated from the second light source 142. When the first shield 320 is positioned in front of the first light source 122 and the second shield 340 is positioned in front of the second light source 142, the light may be directly obstructed. In other words, when light radiated from the first light source 122 and the second light source 142 is obstructed from the outset by disposing the first shield 320 and the second shield 340 in front of the first light source 122 and the second light source 142, respectively, the light may be obstructed and the size of the first shield 320 and the second shield 340 may be minimized while still obstructing the light.

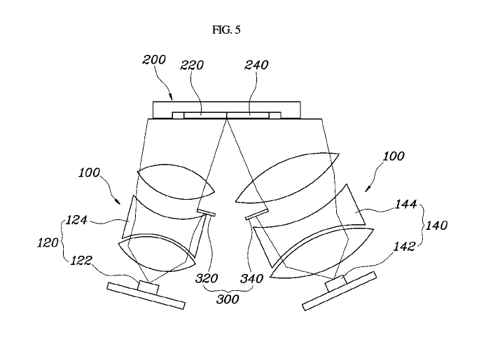

As shown in FIG. 5 that shows another exemplary embodiment, the first shield 320 of the shield unit 300 may be disposed among a plurality of lenses of the first condenser 124 on the path of the light radiated from the first light source 122 and the second shield 340 may be disposed among a plurality of lenses of the second condenser 144 on the path of the light radiated from the second light source 142. The first condenser 124 and the second condenser 144 may be configured to concentrate the light, and each may be a single condensing lens for concentrating light, or may be a prism configured to adjust the degree of condensing or may include a plurality of lenses. In particular, when the first shield 320 and the second shield 340 are disposed among a plurality of lenses of the first condenser 124 and the second condenser 144, respectively, the package may be simplified. Further, to prevent the light radiated from the first light source 122 from entering the second section 240 and the light radiated from the second light source 142 from entering the first section 220 the light beams from the first light source 122 and the second light source 142 may be separated at the joint of the first section 220 and the second section 240 of the reflecting unit 200.

As described above, according to the present invention, two light radiation modules, that is, the first optical unit 120 and the second optical unit 140 may be provided and light beams from the first optical unit 120 and the second optical unit 140 may travel to the entire area of one reflecting unit 200 and may be prevented from mixing by the shield unit 300. When the light beams from the first optical unit 120 and the second optical unit 140 are separated by the shield unit 300 and travel to the entire area of the reflecting unit 200, the efficiency of the light sources may be improved. Further, when the first optical unit 120 or the second optical unit 140 is disposed separately to form a low beam or a high beam a specific image by the low beam or the high beam may be formed clearly on a roadway. According to the lamp apparatus for a vehicle having the structure described above, a specific image in a beam pattern may be formed that increases the visibility of an image and improves light distribution efficiency.

While this invention has been described in connection with what is presently considered to be exemplary embodiments, it is to be understood that the invention is not limited to the disclosed exemplary embodiments, but, on the contrary, is intended to cover various modifications and equivalent arrangements, without departing from the scope and spirit of the invention as disclosed in the accompanying claims.

What is claimed is:

1. A lamp apparatus for a vehicle, comprising:
an optical unit having a plurality of light sources disposed at different positions, and configured to concentrate light radiated from the light sources to a single point;
a reflecting unit disposed on a path of light from the optical unit and configured to reflect the light radiated from the light sources of the optical unit to different paths;
a shield unit disposed between the optical unit and the reflecting unit on the path of the light radiated from the light sources and configured to separate the light traveling to the reflecting unit by obstructing a portion of the light; and
a lens unit configured to receive the light separated by the shield unit and then reflected, and configured to transmit the light to the exterior.

2. The lamp apparatus for a vehicle of claim 1, wherein the optical unit includes:
a first optical unit disposed on the optical unit; and
a second optical unit disposed at a different position than the first optical unit where the first and second optical units are configured to radiate light to the reflecting unit

3. The lamp apparatus for a vehicle of claim 2, wherein the first optical unit includes:
a first light source configured to radiate light and a first condenser configured to condense the light radiated from the first light source.

4. The lamp apparatus for a vehicle of claim 2, wherein the first optical unit includes:
the second optical unit includes a second light source configured to radiate light and a second condenser configured to condense the light radiated from the second light source.

5. The lamp apparatus for a vehicle of claim 2, wherein the reflecting unit is adjusted and configured to reflect the light radiated from the light sources of the optical unit to form an image.

6. The lamp apparatus for a vehicle of claim 5, wherein the reflecting unit is a Digital Micro-mirror Device (DMD) that includes a plurality of micro reflective mirrors that are individually switched, and configured to reflect incident light to form a predetermined image.

7. The lamp apparatus of claim 3, wherein the reflecting unit is divided into a first section configured to receive the light from the first optical unit and a second section configured to receive the light from the second optical unit, and the light reflected from the first section and the second section travels to the lens unit along different paths.

8. The lamp apparatus for a vehicle of claim 7, wherein the lens unit includes:
a first transmissive lens configured to receive the light reflected from the first section of the reflecting unit; and
a second transmissive lens configured to receive the light reflected from the second section.

9. The lamp apparatus for a vehicle of claim 8, wherein the shield unit includes;
a first shield that obstructs a portion of the light from the first optical unit to prevent the light from the first optical unit from traveling to the second section of the reflecting unit; and
a second shield that obstructs a portion of the light from the second optical unit to prevent the light from the second optical unit from traveling to the first section of the reflecting unit

10. The lamp apparatus for a vehicle of claim 8, wherein the first shield of the shield unit is disposed in front of the first condenser on the path of the light radiated from the first light source, and the second shield is disposed in front of the second condenser on the path of the light radiated from the second light source.

11. The lamp apparatus for a vehicle of claim 8, wherein the first shield of the shield unit is disposed in front of the first light source on the path of the light radiated from the first light source, and the second shield is disposed in front of the second light source on the path of the light radiated from the second light source.

12. The lamp apparatus for a vehicle of claim 8, wherein the first shield of the shield unit is disposed within a plurality of lenses of the first condenser on the path of the light radiated from the first light source, and the second shield is disposed within a plurality of lenses of the second condenser on the path of the light radiated from the second light source.
